(19) United States
(12) Patent Application Publication
(10) Pub. No.: US 2018/0073664 A1
(43) Pub. Date: Mar. 15, 2018

(54) IMPROVED SUBSEA TIE BACK CONNECTOR

(71) Applicant: SELF ENERGISING COUPLING COMPANY LIMITED, Wincham, Northwich Cheshire (GB)

(72) Inventor: Matt Readman, Wincham, Northwich Cheshire (GB)

(21) Appl. No.: 15/558,797

(22) PCT Filed: Mar. 16, 2016
(86) PCT No.: PCT/GB2016/050705

§ 371 Date: Sep. 15, 2017

(30) Foreign Application Priority Data
Mar. 16, 2015 (GB) 1504401.9

(51) Int. Cl. F16L 1/09; F16L 1/26; F16L 27/12

(52) U.S. Cl. CPC F16L 1/09; F16L 27/12; F16L 1/26

(57) ABSTRACT

A tie back connector having a telescoping section wherein a distal end of the telescoping section is sealed to a detachable component by a compression clamp and the telescoping section is sealed by a tension clamp. The detachable component and a second component are coupled by extending the telescoping section of the second component to fill a gap between the detachable component and second component and sealing the detachable component to the second component using the compression clamp and sealing the telescoping section using the tension clamp.

The present invention relates to an improved sub-sea tie back connector for pipeline connections and in particular although not exclusively, to sub-sea pipeline connections joining pipelines to manifolds.

Subsea tie back connectors are known. Here, the connection involves mating a pipeline to a manifold and sealing the join to create the fluid passageway. However, the applications are not limited, and can for instance be used to join two pipelines. Relative movement between the two parts being connected in the axial direction of the pipeline is required to make a seal. Known tie back connectors involve pulling the pipeline towards the manifold. Since the pipelines are typically rigid metal pipes and connected beyond diving depth by remotely operated vehicles (ROV), known tie back connectors are very large, well-engineered pieces of equipment including hydraulic rams powered to affect the force required to pull the pipeline.

The tie back connectors are typically installed on marginal fields and the tie back connector equipment remains subsea. Consequently, to reduce the costs of tapping these multiple small reserves, it is advantageous if the cost of the subsea tie back can be reduced.

It is an object of the present invention to attempt to overcome at least one of the above or other disadvantages. It is a further aim to provide a tie back connector that provides a more efficient way to connect a pipeline by reducing the cost of the equipment left subsea.

According to the present invention there is provided an apparatus and method as set forth in the appended claims. Other features of the invention will be apparent from the dependent claims, and the description which follows.

According to the exemplary embodiments, there is provided a tie back connector having a telescoping section wherein a distal end of the telescoping section is sealed to a detachable component by a compression clamp and the telescoping section is sealed by a tension clamp.

In the exemplary embodiments, the telescoping section comprises a first telescoping part and a second telescoping part. Here, the first telescoping part is slideable within the second telescoping part. Consequently, a gap between the detachable component, for instance the pipeline, and a second component, for instance a manifold, can be filled by extending the first telescoping part relative to the second. That is relative movement in an axial direction and between the first and second telescoping parts moves the distal end of the telescoping section towards the detachable component. The force required to extend the telescoping section is significantly lower than the force required in known tie back connectors to pull a pipeline. Consequently, the tie back connector can be engineered to a lower specification and less high value components used in the tie back connector.

In the exemplary embodiments, the second telescoping section is formed with an enlarged internal cross-sectional area. Advantageously, this enables the first telescoping section to have a constant internal cross-section with the other components.

The telescoping section is sealed by a tension clamp. This means that rather than pulling the two sides components towards each other as with a compression clamp, the two components are pushed together. In the exemplary embodiments, the first telescoping section includes an outwardly extending lip and the second telescoping part comprises an inwardly extending rim. The rim and lip are arranged to abut each other as the two telescoping parts are extended and such that abutment of the rim and lip prevents further movement of the telescoping parts. A seal is typically arranged between the lip and rim and compression of the seal provides a fluid tight seal as is known in the art with compression clamps. The tension clamp is achieved by arranging a clamp to act between two anchors. The anchors are fixed to the first and second telescoping parts respectively. Here the clamp is caused to expand to push against the two anchors thereby acting to force the two anchors apart. Because the rim and lip are arranged within the telescoping part, the force acts to force the rim and lip into contact, making the seal.

Suitably, the tension clamp comprises a clamp able to be actuated to expand. For instance, the clamp may comprise first and second opposed surfaces. Said surfaces being tapered, such that as the surfaces are caused to move towards the central axis, the tapered surfaces act against corresponding tapered surfaces of the anchors. Here, the tapered surfaces of the anchors and clamp are arranged in an opposite orientation to a compression clamp. That is, the tapered surfaces are closer together at a point towards the central axis than a point further away from the central axis. The clamp may be a split ring design actuated to be contracted by moving the ends of the split ring towards each other, or the clamp may be a two part clamp, with the two parts being arranged to be moved towards each other, or the clamp may be any other known clamp able to move the tapered surfaces, and in particular, known clamps from compression clamps.

In the exemplary embodiments, the tension clamp acts between an anchor on the second telescoping parts. Here, the distal end of the second telescoping part comprises the anchor. In the exemplary embodiments, the distal end of the second telescoping section is tapered to act against the tapered surface of the clamp.

In the exemplary embodiments, the tension clamp acts between an anchor on the first telescoping part. Here, the anchor is suitably a tapered surface on the first telescoping part. The tapered surface is shown as being spaced from the distal end of the first telescoping part so as not to interfere with the distal flange and operation of the compression clamp sealing the flange to a flange of another component. The first and second telescoping parts might be sized so that the distal flange can pass through the rim of the second telescoping part so that during manufacture, the first telescoping part can be passed through the second. However, in the exemplary embodiments, and to allow the internal fluid passageway to remain substantially consistent in size, the distal flange may be sized so as not to pass through the rim. Consequently, the first telescoping part may be formed in two parts. The first part is shown as being joined at the tapered surface.

The compression clamp is arranged to compress two parts. Suitably, the compression clamp includes two opposed surfaces. The opposed surfaces are tapered such that when the clamp is actuated, the tapered surfaces move toward the central axis and act against tapered surfaces of anchor points on the respective parts being clamped to compress said parts together. The tapered surfaces being arranged to be closer together at a point spaced further from the central axis than another point. Compression clamps are known and suitably, the compression clamp may be a known or any other suitable clamp for compressing flanges of the two parts together.

In the exemplary embodiments the tie back connector includes a frame. The frame includes location points for detachably connecting the component to be joined. Here the compression clamp is assembled to the frame to aid locating the compression clamp about the flanges of the detachable component and end of the telescoping section. Typically, the frame is attached to the part being connected. An actuator is suitably provided to actuate the extension of the telescoping section. Here, the actuator is carried by the frame and acts between the frame or an anchor point fixed relative to the second telescoping part and the first telescoping part. Depending on the type of clamping arrangements, the compression and tension clamp may also be carried on the frame and caused to move with the first telescoping part. Advantageously, here the tension clamp includes a floating mechanism relative to the first to accommodate tolerance in the positioning of the respective tapered surfaces of the tension clamp arrangement.

In the exemplary embodiments there is provided a method of connecting a detachable component and a second component. The method comprises extending a telescoping section of the second component to fill a gap between the detachable component and second component and sealing the detachable component to the second component using a compression clamp and sealing the telescoping section using a tension clamp.

In the exemplary embodiments, the method comprises operating the compression clamp to compress a flange of the detachable component against a flange of the second component. Here, the method typically comprises moving a tapered surface of the clamp to bear against a tapered surface of one of the parts being clamped such that as the tapered surface of the clamp moves towards the central axis, the tapered surfaces bear against each other to provide the compression force.

In the exemplary embodiments, the method comprises operating the tension clamp to expand. Here expansion of the clamp acts to urge the telescoping section further apart. Said expansion mating a lip and rim of the telescoping section to enact a seal there between.

In the exemplary embodiments, the method comprises locating the detachable part on a frame of the tie back connector. Preferably, the method comprises actuating an actuator to cause the telescoping section to expand to fill the gap. Movement of the telescoping section may move the compression clamp into alignment. Suitably, the tension clamp may self-align by relative movement with the compression clamp. That is the tension clamp may be arranged to float relative to the frame and the method comprises allowing axial movement of the compression clamp as the compression clamp is actuated.

For a better understanding of the invention, and to show how embodiments of the same may be carried into effect, reference will now be made, by way of example, to the accompanying diagrammatic drawings in which:

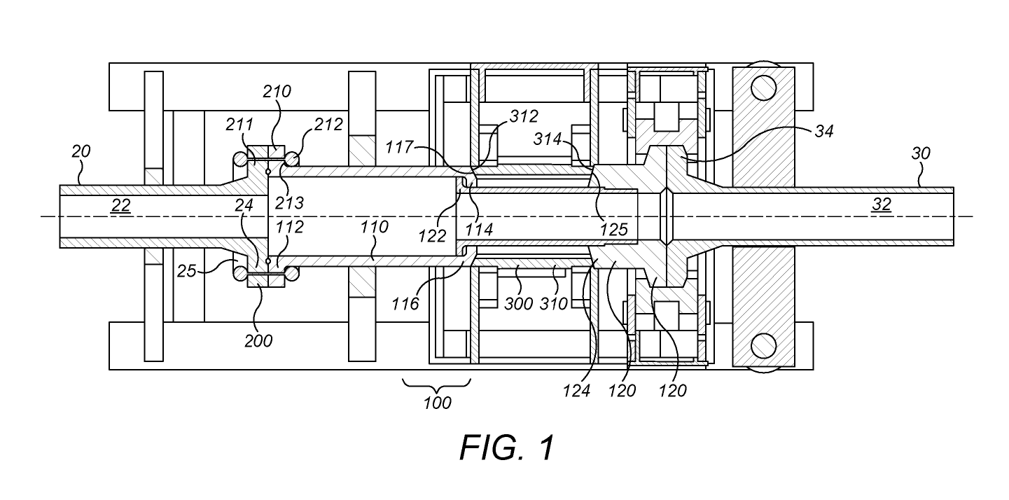

FIG. 1 is a simplified cross-sectional view through a part mated tie back connector assembly according to an exemplary embodiment;

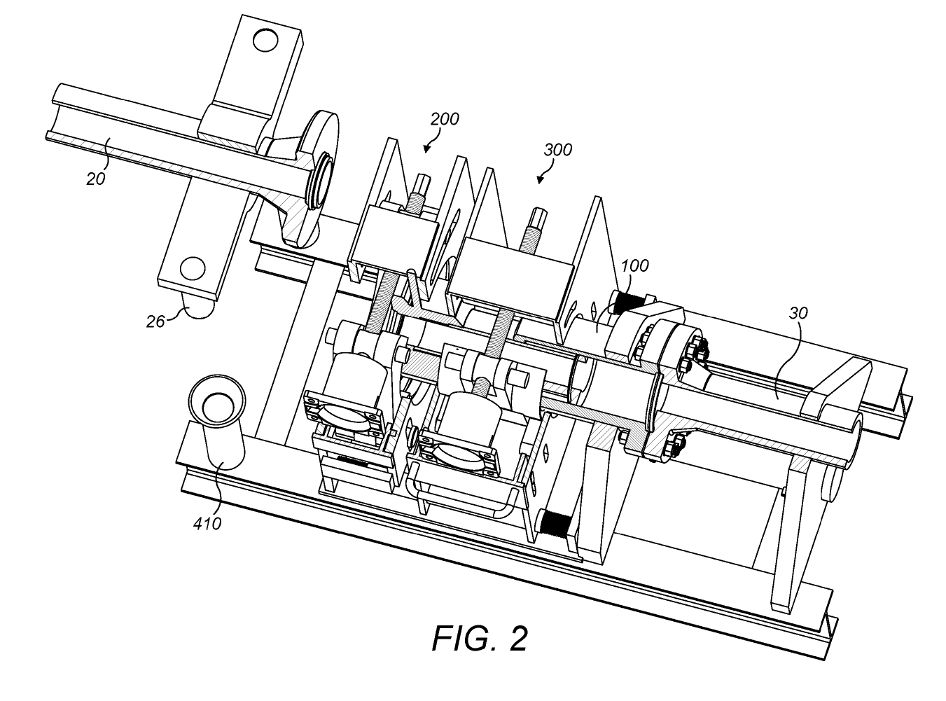

FIG. 2 is a partial cut away perspective view of a tie back connector according to an exemplary embodiment in an unmated state;

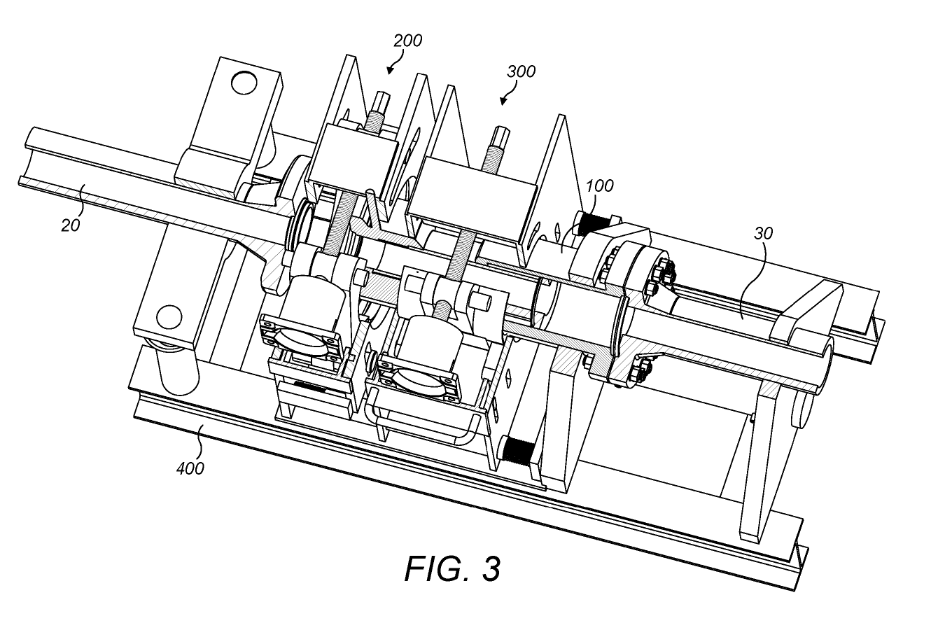

FIG. 3 is a partial cut away perspective view of a tie back connector according to an exemplary embodiment in a pre mating state;

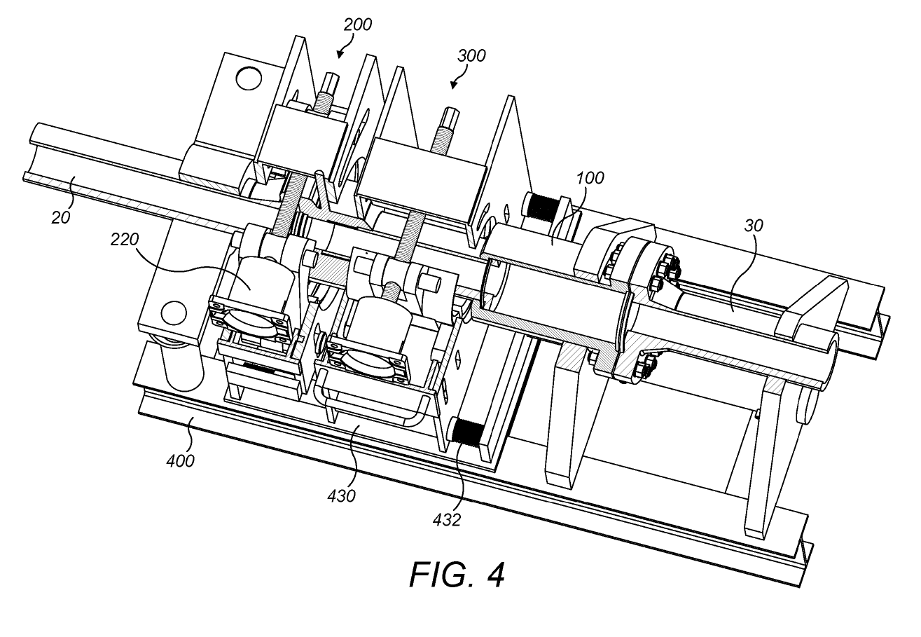

FIG. 4 is a partial cut away perspective view of a tie back connector according to an exemplary embodiment in an unsealed mated state; and

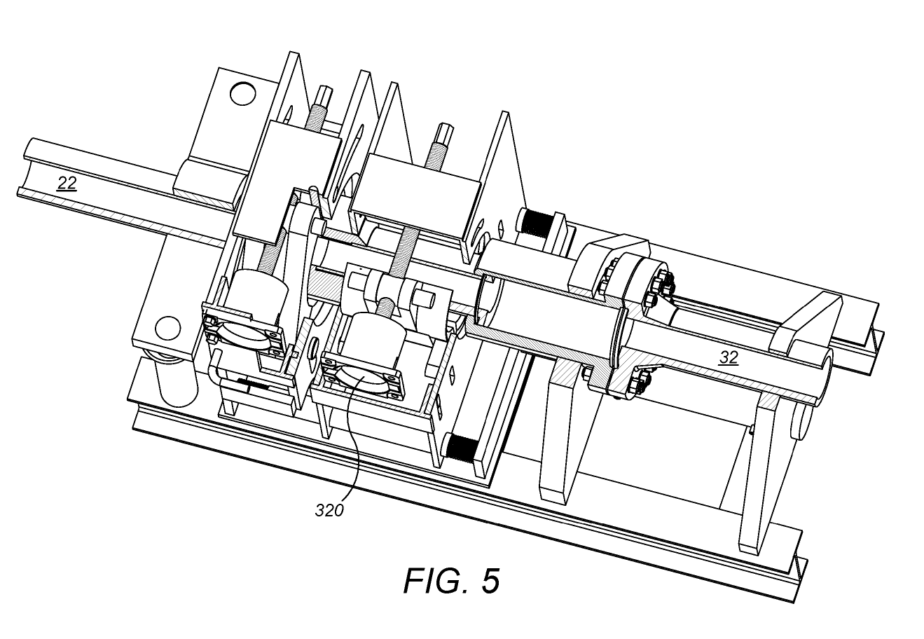

FIG. 5 is a partial cut away perspective view of a tie back connector according to an exemplary embodiment in a sealed and mated state.

Referring to FIG. 1 there is provided a connector 10. The connector 10 is arranged to connect between a detachable part 20 and a second part 30. Here the detachable part 20 is a pipeline having a fluid passageway 22, and the second part is a manifold having a corresponding fluid passageway 32. The connector 10 is connected to the manifold to act as an extension of the manifold 30. For instance, the connector is bolted to a flange 34 of the manifold 30. Alternatively, the connector 10 could be formed integrally to the manifold.

The connector comprises a telescoping part 100, a compression clamp 200 and a tension clamp 300. The telescoping section comprises a first telescoping part 110 and a second telescoping part 120. The first telescoping part 110 is arranged to extend and contract relative to the second telescoping part

The compression clamp 200 acts to seal a distal end 112 of the first telescoping section to a distal end flange 24 of the detachable part. Here, the distal end 112 is formed as a flange to correspond to the end of the detachable part. Compression clamps are known in the art and comprise a clamp 210 that fits over the respective flanges or hubs. The clamp 210 is activated to constrict. In doing so, tapered surfaces 212 of the clamp 210 bear against corresponding tapered surfaces 25, 113 of the flanges. As the clamp is constricted towards a central axis of the fluid passageway, the flanges are urged together. Known compression clamps include a seal ring that deflects against the inner surfaces of the flanges as the clamp draws the two flanges together to create a metal-to-metal seal. Any known compression clamp is envisaged. However, a particularly suitable compression clamp is supplied under the Trade Mark Grayloc and is well known in the industry.

As the compression clamp is applied, the detachable part and connector move relative to each other in the axial direction. Moreover, to enable the detachable part to be brought in to proximity with the connector with appropriate tolerances, the relative movement needs to be accommodated in the system. In the exemplary embodiments, it is the telescoping section 100 that accommodates the movement. Here, the first part 110 extends from the second part 120 to fill the gap. As shown, the first part 110 is arranged in a stowed position within the second part 120. It will be appreciated that it is necessary to seal between the two telescoping parts. Whilst simple o-ring seals between the sliding parts may be suitable in some applications, o-ring seals are not always suitable, for instance where metal-to-metal seals are required. In the exemplary embodiments, the seal is achieved using the tension clamp 300.

The tension clamp seals the telescoping parts by pushing an outwardly extending lip of one of the telescoping parts against an inwardly extending rim of the other. It will be appreciated that the rim and lip will be formed on the parts dependent on whether the first part slides externally or internally to the second part. The Figures show the first part sliding internally, and the description from herein will be limited to that arrangement. However, it will be appreciated that the same principals would apply with appropriate modifications to the first part sliding externally to the second part.

The first part slides within the second part. A distal end of the second part includes the inwardly extending rim 122. The rim constricts the bore within which the first part fits. The first part includes the outwardly extending lip 12. Abutment of the rim 122 and lip 114 limit the stroke of the telescoping section. In addition, the rim and lip act as the flanges of the compression clamp that are urged together to seal. For instance, in accordance with known compression clamps, the rim and lip may be appropriately arranged and a seal ring may be arranged there between to deform as the tension clamp forces draw the rim and lip together.

The tension clamp 300 acts against anchors fixed relative to the first and second telescoping parts respectively. In the figures, the anchors are shown as flanges formed directly on the first and second telescoping parts. For instance flange 124 and 116. The clamp 300 is arranged to expand to bear against the flanges and urge them apart. It will be appreciated that this urging apart generates the forces drawing the rim and lip into sealing arrangement. The tension clamp 300 comprises a clamp 310 having tapered surfaces 312, 314 that oppose each other. The tapered surfaces 312, 314 bear against tapered surfaces 117, 125 of the respective flanges. Again, the tapered surfaces are engineered in accordance with the respective tapered surfaces of the known compression clamps. The difference being the arrangement of the tapered surfaces. In compression clamps, the tapered surfaces of the clamp are internal. That is, the tapered surfaces are arranged to be spaced closer together at a location spaced from the central axis. In contrast, the clamp 310 of the tension clamp is arranged to have external tapered surface. Here the clamp 31 acts as a wedge between the flanges to urge them apart. That is, the opposed tapered surfaces 312, 314 of the clamp 310 are arranged to be closer together in an axial direction at a position spaced closer to the central axis.

It will be appreciated by those skilled in the art that the clamp 310 may include many of the applicable features of known compression clamps. For instance, it is known to be beneficial to have different types of clamp 310, for instance multiple parts or split rings and many of these benefits and technologies are readily transferable to the clamp 310.

The operation of the connector 10 will now be described with reference to FIGS. 2-5. FIGS. 2-5 show more detail of the connector. However, the principal operation of the connector is as described in relation to simplified FIG. 1 and therefore like reference numerals refer to like parts and a detailed description in relation to FIGS. 2-5 will not therefore be given.

FIG. 2 shows the connector in an unmated state. The connector 10 comprises a telescoping part 100, compression clamp 200 and tension clamp 300. A frame 400 carries the components. The frame 400 includes a locator 410 for locating pins 26 assembled to the detachable part. This enables the detachable part to be easily offered to the connector and such locators are known in the art. Consequently, the first stage of the connection process is to arrange the detachable part on the frame in position and as shown in FIG. 3.

Referring to FIG. 4, once offered up, the gap between the detachable part and distal end of the telescoping section is closed by extending the telescoping section. This is achieved using an actuator 420. The actuator acts against the frame and pushes the first telescoping section towards the detachable part. As shown, the compression clamp is assembled to the frame in a sliding manner so that the compression clamp is moved with the first telescoping part. For instance the compression clamp may be directly connected in the axial direction to the first telescoping part. Once the gap is closed as shown in FIG. 4, the compression clamp can be actuated to seal the flanges. Once sealed, the detachable part and first telescoping section are fixed fast to each other. ROV buckets 220 are provided to allow activation of the clamp 310 as is known in the art.

The tension clamp 300 is assembled to the frame on a sliding carriage 430. As shown the compression clamp is also assembled to the sliding carriage such that the tension clamp 300 moves with the compression clamp 200. To allow for tolerance, the tension clamp floats on the carriage so that as it is actuated, the clamp 310 can self-centre between the respective flanges. A spring 432 maintains urges the tension clamp to an initial optimal position.

The connection is fully sealed by operating the tension clamp 300. Again, as is known in the art, an ROV bucket 320 is provided to allow the ROV to operate the clamp 300. Once fully sealed a fluid passageway is formed through the connector to allow transmission of fluid between passageways 22 and 32.

The exemplary embodiments provide an improved connector wherein the gap between the respective parts being coupled is filled by a telescoping part rather than by stretching or movement elsewhere in the system. This allows the connection to be made using lower tolerances and reduced forces, which means the connector can be lower cost and complexity to known connectors. Advantageously, the connector provides metal-to-metal seals as is required in a number of applications.

Although a few preferred embodiments have been shown and described, it will be appreciated by those skilled in the art that various changes and modifications might be made without departing from the scope of the invention, as defined in the appended claims.

1. A connector (10) for connecting a detachable part (20) to a second part (30), the connector comprising a telescoping section (100), a compression clamp (200) and a tension clamp (300); wherein
the telescoping section (100) comprises a first telescoping component (110) and a second telescoping section (120);
the compression clamp is arranged to urge a distal end of the first telescoping section to seal against a distal end of said detachable part; and
the tension clamp (300) is arranged to seal the first telescoping section (110) to the second telescoping section (120).

2. The connector (10) of claim 1, wherein the second telescoping section (120) is formed with an enlarged internal cross-sectional area.

3. The connector (10) according to claim 1, wherein the first telescoping section includes an outwardly extending lip and the second telescoping part comprises an inwardly extending rim, the rim and lip being arranged to abut each other as the telescoping section is extended and wherein a seal is arranged between the lip and rim and compression of the seal between the lip and rim provides a fluid tight seal

4. The connector (10) according to claim 1, wherein the tension clamp is pushes against two anchors fixed to the first and second telescoping parts respectively and acts to force the two anchors apart.

5. The connector (10) according to claim 1, wherein the tension clamp comprises first and second opposed surfaces and said surfaces are tapered, such that, as the surfaces are caused to move towards the central axis, the tapered surfaces act against corresponding tapered surfaces.

6. The connector (10) of claim 1, wherein the compression clamp is arranged to compress two parts and the compression clamp includes two oppositely tapered surfaces such that when the clamp is actuated, the tapered surfaces move toward the central axis and act against surfaces on the respective parts being clamped to compress said parts together.

7. The connector (10) of claim 1, wherein the connector comprises a frame and said frame includes location points for detachably connecting the component to be joined.

8. The connector (10) of claim 7, wherein an actuator acts against the frame to actuate the extension of the telescoping part.

9. The connector (10) of claim 7 or 8, wherein the tension clamp includes a floating mechanism to allow relative movement between the tension clamp and frame.

10. A method of connecting a detachable part (20) to a second part (30), the method comprising using a connector (10) of any preceding claim, and
extending a telescoping section (100) to fill a gap between said detachable part and a distal end of the telescoping section;
actuating a compression clamp (200) to seal the distal end of the telescoping section to a distal end of the detachable part (20); and
actuating a tension clamp (300) to seal a first telescoping section (110) to a second telescoping section (120).

11. The method of claim 10, wherein the method comprises operating the compression clamp to compress a flange of the detachable part against a flange of the second part.

12. The method of claim 10 or 11, wherein the method comprises operating the tension clamp to expand.

13. The method of claim 10, wherein the method comprises locating the detachable part on a frame to form a tie back connector.

14. The method of claim 13, wherein the method comprises actuating an actuator to cause the telescoping section to expand to fill the gap.

15. The method of claim 1, wherein the tension clamp is arranged to float relative to the frame and the method comprises allowing axial movement of the compression clamp as the compression clamp is actuated.
